(19) United States
(12) Patent Application Publication
(10) Pub. No.: US 2026/0160624 A1
(43) Pub. Date: Jun. 11, 2026

(54) SENSOR DEVICE

(71) Applicant: Kistler Holding AG, Winterthur (CH)

(72) Inventors: Pirouz Sohi, Winterthur (CH); Hanspeter Oldrati, Wangi (CH); Roland Sommer, Neftenbach (CH); Christoph Naegeli, Wangi (CH)

(21) Appl. No.: 19/406,110

(22) Filed: Dec. 2, 2025

(30) Foreign Application Priority Data
Dec. 6, 2024 (EP) 24217955.4

(51) Int. Cl. G01L 9/00; G01L 19/14

(52) U.S. Cl. CPC G01L 9/008; G01L 19/14

(57) ABSTRACT

A sensor device to measure a pressure includes a base body defining a diaphragm on which piezoelectric sensor material is formed to generates charge upon deflection of the diaphragm under the effect of the pressure. A ratio of the diaphragm's thickness to its diameter is configured so that the sensor device has a natural frequency of greater than or equal to 1 MHz.

### TECHNICAL FIELD

The invention relates to a sensor device that has a natural frequency of at least one megahertz and configured to measure pressures occurring during fast processes such as sudden explosions.

### BACKGROUND OF THE INVENTION

Sensor devices are well known. They are used in a variety of ways to measure a pressure, a temperature and the like.

Thus, sensor devices are known which measure a pressure according to the piezoelectric measuring principle. For this purpose, they comprise piezoelectric material such as quartz (SiO₂), gallium orthophosphate (GaPO₄) and the like which generates piezoelectric charges under the effect of the pressure to be measured. The piezoelectric charges are generated on the surfaces of the piezoelectric material and are tapped by means of electrodes. The quantity of piezoelectric charges generated is proportional to the magnitude of the measured pressure.

Piezoelectric material such as SiO₂ and GaPO₄ exhibits a very high profile rigidity. Due to this very high profile rigidity, piezoelectric sensor devices have a high natural frequency of more than 500 kilohertz (kHz). Due to this high natural frequency, piezoelectric sensor devices are predestined for dynamic pressure measurements. Generally, the maximum measuring frequency of the sensor device employing piezoelectric material is ⅓ of the natural frequency of the pressure variations being measured by the sensor device.

Such a piezoelectric sensor device for the dynamic measurement of pressure is sold by the applicant under the designation type 603C. In type 603C, the piezoelectric material formed as a plurality of disks is spaced apart in the axial direction from a diaphragm by a base plate. The pressure to be measured acts as a force on the piezoelectric material via said diaphragm and said base plate. As the piezoelectric material such as SiO₂ and GaPO₄ is brittle and can break under local pressure peaks, the base plate ensures an even distribution of the pressure on the piezoelectric material. The maximum measuring frequency of type 603C is about 200 kHz. The technical specifications of type 603C are documented in data sheet No. 603C_003-288e-11.22.

### OBJECTS AND SUMMARY OF THE INVENTION

Now, users of sensor devices for measuring pressure wish to further increase the measurement frequency (also known as the measuring frequency), which is the number of pressure measurements that the sensor device can process per unit of time.

It accordingly is the principal object of the present invention to provide a sensor device having a measuring frequency of significantly more than 200 kHz for measuring the pressure.

This primary object is achieved by the features described herein.

The invention relates to a sensor device adapted for measuring a pressure and comprises at least one base body and at least one sensor material. The base body is formed as a base body diaphragm in some regions of the base body, and the base body diaphragm defines a thickness measured in a direction along a vertical axis and a diameter measured in a direction that lies in a horizontal plane perpendicular to the vertical axis. The base body diaphragm is configured to receive the pressure to be measured by undergoing a deflection that bulges along the vertical axis under the impact of said pressure. The sensor material is disposed on the base body diaphragm and configured to generate piezoelectric charge due to the deflection of the base body diaphragm, and a quantity of the piezoelectric charge generated is proportional to the magnitude of the measured pressure. The thickness of the base body diaphragm is less than or equal to 20 μm, preferably less than/equal to 10 μm, preferably less than/equal to 5 μm. The diameter of the base body diaphragm is less than or equal to 300 μm, preferably less than or equal to 200 μm, preferably less than or equal to 100 μm. The ratio of the thickness to the diameter of the base body diaphragm is configured in such a way that the sensor device has a natural frequency of greater than or equal to 1 MHz, and accordingly is capable of measuring the sensed pressure at least one million times per second.

Advantageous embodiments of the invention are described below with greater elaboration on more of their particulars.

### BRIEF DESCRIPTION OF THE DRAWINGS

In the following, the invention is explained in more detail by way of example with reference to the Figures in which

FIG. 1 shows a plan view of a part of a first embodiment of a sensor device 1 comprising a pressure sensor 1P for measuring a pressure P;

FIG. 2 shows a cross-section of a part of the sensor device 1 as shown in FIG. 1 along a section path A-A;

FIG. 3 shows a plan view of a part of a second embodiment of a sensor device 1 comprising a group of pressure sensors 1P as shown in FIG. 1;

FIG. 4 shows a schematic circuit diagram of a part of the first embodiment of the sensor device 1 comprising a pressure sensor 1P according to FIG. 1 or 2, comprising a transmission device 5, comprising a transducer unit 6, and comprising an evaluation unit 7; and

FIG. 5 shows a schematic circuit diagram of a part of the second embodiment of the sensor device 1 comprising a group of pressure sensors 1P according to FIG. 3, comprising a transmission device 5, comprising a transducer unit 6, and comprising an evaluation unit 7.

Throughout the figures, identical reference numerals denote identical objects in the Figures.

### DETAILED DESCRIPTION OF EXEMPLARY EMBODIMENTS OF THE INVENTION

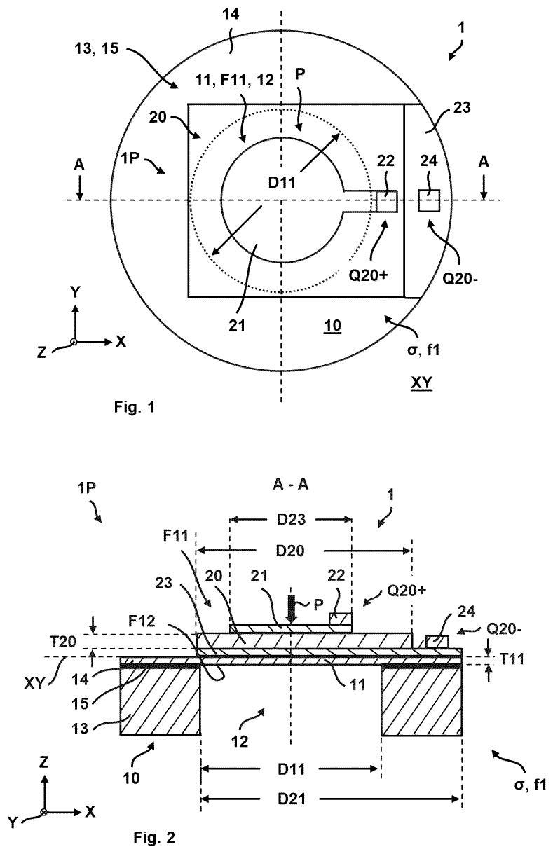

The sensor device 1, which is schematically represented in a plan view from above in FIG. 1 and in FIG. 2 in a cress-sectional view looking in the direction of the arrows pointing in FIG. 1, is configured to perform the function of measuring a pressure P that applies a force along the direction of the bold typeface arrow designated P in FIG. 2.

As shown in the embodiments of FIGS. 1 to 3, the sensor device 1 comprises at least one pressure sensor 1P for measuring the pressure P.

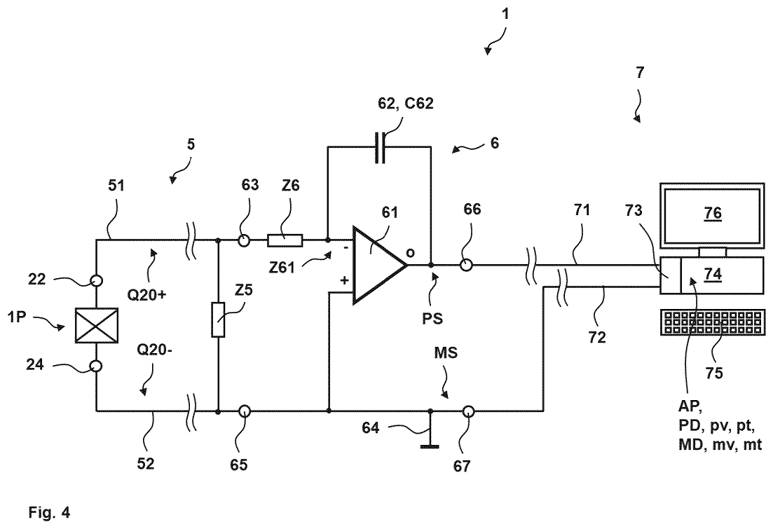

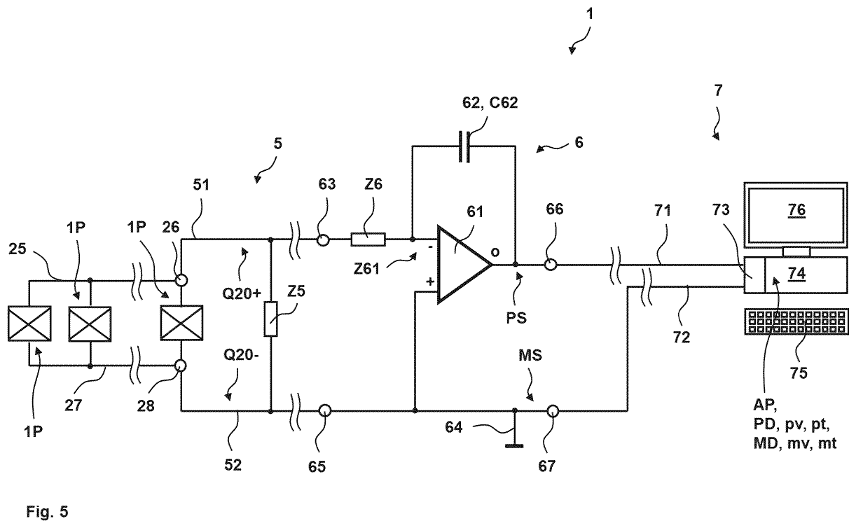

Furthermore, as shown in FIGS. 4 and 5, the sensor device 1 comprises at least one transmission device 5, at least one transducer unit 6, and at least one evaluation unit 7.

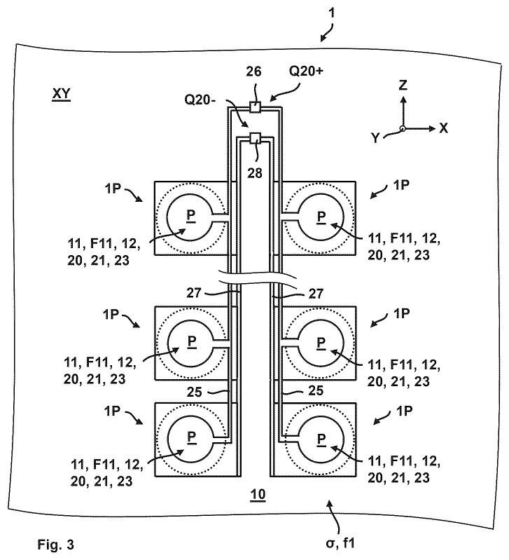

In FIGS. 1 to 3, the sensor device 1 is shown in a three-dimensional coordinate system that defines a horizontal axis X, a transverse axis Y and a vertical axis Z, also referenced as a longitudinal axis Z. The three axes X, Y, Z are perpendicular to each other. The horizontal axis X and the transverse axis Y span a horizontal plane XY. FIGS. 1 and 3 show embodiments of the sensor device 1 in a plan view in the horizontal plane XY. FIG. 2 shows the sensor device 1 in cross-section.

### The Base Body 10

The sensor device 1 comprises at least one base body 10 that is configured to perform the function of sensing the pressure P to be measured.

Said base body 10 is made of electrically insulating material such as silicon, glass and the like. Silicon has a specific electrical resistance of greater than or equal to 10⁷ ohm-meters (Ωm) at room temperature (20° C.). Glass has a specific electrical resistance of greater than or equal to 10¹¹ Ωm at 20° C.

The base body 10 defines a front side and a rear side disposed opposite to the front side so that the front side and the rear side face away from each other. On the front side, the base body 10 forms a supporting surface. Said supporting surface is located in the horizontal plane XY. Said supporting surface is defined by an area that measures less than or equal to 3 mm*3 mm, preferably less than or equal to 2 mm*2 mm in size. On the rear side, as schematically shown in FIG. 2, the base body 10 forms a base body opening 12 that extends along the longitudinal axis Z to the front side but not through the front side.

Preferably, said base body 10 is a Silicon-On-Insulator (SOI) comprising the following functional layers:
A supporting layer 13 is made of silicon and defines a thickness along the vertical axis Z in the range from 200 to 500 μm, preferably the supporting layer 13 has a thickness of 400 μm. The supporting layer 13 is configured to perform a supporting function for components of the sensor device 1.
A boundary layer 14 made of silicon defines a thickness along the vertical axis Z in the range from 100 to 2 μm, preferably a thickness of 50 μm, preferably a thickness of 5 μm. Said boundary layer 14 is configured to perform the function of forming a base body diaphragm 11 in some regions. Said boundary layer 14 is configured to delimit the base body 10 in the horizontal plane XY.
A stop layer 15 defines a thickness of 1 micrometer (μm) along the vertical axis Z and is disposed along the vertical axis Z between the supporting layer 13 and the boundary layer 14. Said stop layer 15 is made of an oxide material and has a specific electrical resistance of greater than or equal to 10¹² Ωm at 20° C. Therefore, the function of the stop layer 15 is to electrically insulate the boundary layer 14 from the supporting layer 13. Said stop layer 15 has the further function of an etch stop during the production of the base body opening 12 by chemical etching in the base body 10. During production, silicon is etched off on the rear side of the base body 10 along the vertical axis Z up to the stop layer 15.

The base body diaphragm 11 is configured to sense the pressure P to be measured. The base body diaphragm 11 defines two surfaces F11, F12. The two surfaces F11, F12 define a front surface F11 and a rear surface F12. The front surface F11 is located on the front side of the base body 10 in the horizontal plane XY. The pressure P acts along the vertical axis Z onto the front surface F11. The front surface F11 faces the direction in which the pressure P acts. The rear surface of the base body diaphragm 11 defines the base body opening 12 on the rear side of the base body 10. Under the effect of the pressure P, the base body diaphragm 11 is configured so that it can be deflected along the vertical axis Z into the base body opening 12.

The base body diaphragm 11 defines a thickness T11 measured along the longitudinal axis Z of less than or equal to 20 μm, preferably less than or equal to 10 μm, preferably less than or equal to 5 μm. The base body diaphragm 11 has a diameter D11 of less than or equal to 300 μm, preferably less than or equal to 200 μm, preferably less than or equal to 100 μm. The ratio of the thickness T11 to the diameter D11 of the base body diaphragm 11 is configured in such a way that the sensor device 1 has a natural frequency f1 of greater than or equal to 1 MHz. Advantageously, the ratio of the thickness T11 to the diameter D11 of the base body diaphragm 11 is in the range from 1.7 10⁻² to 5.0 10⁻². Exemplary ratios of thickness T11 to diameter D11 of the base body diaphragm 11 result in the following natural frequencies f1:
For a thickness T11 of the base body diaphragm 11 equal to 5 μm and a diameter D11 of the base body diaphragm 11 equal to 300 μm, the resulting ratio of the thickness T11 to the diameter D11 of the base body diaphragm 11 is equal to 1.7 10⁻² and a resulting natural frequency f1 is greater than 1 MHz.
For a thickness T11 of the base body diaphragm 11 equal to 5 μm and a diameter D11 of the base body diaphragm 11 equal to 200 μm, the resulting ratio of the thickness T11 to the diameter D11 of the base body diaphragm 11 is equal to 2.5 10⁻² and a resulting natural frequency f1 is greater than 2.5 MHz.
For a thickness T11 of the base body diaphragm 11 equal to 5 μm and a diameter D11 of the base body diaphragm 11 equal to 100 μm, the resulting ratio of the thickness T11 to the diameter D11 of the base body diaphragm 11 is equal to 5.0 10⁻² and a resulting natural frequency f1 is greater than 10 MHz.

In contrast to the piezoelectric sensor device of type 603C, which comprises a metallic diaphragm made of stainless steel 17-4PH, the base body diaphragm 11 according to the invention is made of silicon. Compared to stainless steel 17-4PH, which has a density of 7.8 g/cm³, silicon has a density of 2.3 g/cm³. Therefore, said base body diaphragm 11 according to the invention is more than three times lighter, which further increases the natural frequency f1 of the sensor device 1.

### The Sensor Material 20

The sensor device 1 comprises at least one sensor material 20. Said sensor material 20 is configured to perform the function of generating a measured value for the pressure P to be measured.

Said sensor material 20 is piezoelectric, and examples of sensor material include quartz (SiO₂), gallium orthophosphate (GaPO₄), calcium gallo germanate (Ca₃Ga₂Ge₄O₁₄ or CGG), langasite (La₃Ga₅SiO₁₄ or LGS), tourmaline, aluminum nitride (AlN), lead zirconate titanate (PZT), aluminum scandium nitride (Al(1−x)Sc(x)N with x=0 . . . 0.4), potassium sodium niobate (K(x)Na(1−x)NbO3 with x=0.2 . . . 0.5) and the like.

The sensor material 20 is carried by the base body 10. Preferably, said sensor material 20 is carried on the front side of the base body 10 in at least one region of the base body diaphragm 11.

The front surface of the base body diaphragm 11 is generally indicated in FIG. 2 by the designation F11. Preferably, as schematically shown in FIG. 2, said sensor material 20 is disposed in some regions above the front surface F11 of the base body diaphragm 11. The sensor material 20 forms a layer extending in the horizontal plane XY. In the horizontal plane XY, the sensor material 20 defines a base area D20. The base area D20 is greater than or equal to the diameter D11 of the base body diaphragm 11. Said sensor material 20 has a constant thickness T20 along the vertical axis Z. The thickness T20 is less than or equal to 10 μm, preferably the thickness T20 is less than or equal to 5 μm, preferably the thickness T20 is less than or equal to 1 μm.

This thickness T20 of the layer of sensor material 20 desirably is formed by a standard sputtering process. For example, for aluminium nitride (AlN) as sensor material 20, a rod made of aluminium (Al) is sputtered with an Argon (Ar) plasma. The aluminum rod is placed next to the whatever surface is to receive the layer of sensor material 20 up to the desired thickness T20. Due to the Argon-sputtering, small aluminum particles are ejected to that receiving surface. The entire set-up (Al-rod and receiving surface) is placed in a Nitrogen (N) atmosphere. In the nitrogen atmosphere, molecular and atomic nitrogen reacts with the aluminum particles and forms aluminum nitride (AlN) that adheres to the receiving surface, which can be second sensor electrode 23 as schematically shown in FIG. 2.

In contrast to the present invention's thin layer (thickness T20) of sensor material 20 described above, the piezoelectric sensor device of type 603C comprises the sensor material in the form of three disks, each having a thickness of 0.2 mm (200 μm) and being 3.5 mm in diameter. Viewed in the axial direction, the disks are spaced apart from the diaphragm by a metallic base plate having a thickness of 0.6 mm and a diameter of 3.5 mm. In further contrast to the piezoelectric sensor device of type 603, the sensor material 20 is configured according to the invention as a thin layer on the base body diaphragm 11. The thickness T20 of the thin layer of the sensor material 20 is less than or equal to 10 μm. This means that there are no disks of sensor material and there is also no metallic base plate so that the weight of the sensor device 1 according to the invention is reduced. Furthermore, since the natural frequency f1 is inversely proportional to the weight of the sensor device 1, the natural frequency f1 of the sensor device 1 increases due to the absence of the disks of sensor material and the metallic base plate that would be present in a device of type 603C.

Under the effect of the pressure P to be measured, said sensor material 20 generates piezoelectric charge Q20+, Q20− as the measured value. The pressure P acts along the vertical axis Z unidirectionally onto the front surface F11 of the base body diaphragm 11 and deflects the base body diaphragm 11. In FIG. 2 the pressure P is schematically shown as an arrow in bold typeface. Said piezoelectric material 20 generates piezoelectric charge Q20+, Q20− as a result of the deflection of the base body diaphragm 11. The amount of the piezoelectric charge Q20+, Q20− generated is proportional to the magnitude of the measured pressure P. The permanent operating temperature of the sensor material 20 is in the range from −40° C. to +500° C.

The piezoelectric charge Q20+, Q20− is generated on a plurality of surfaces of the sensor material 20, which surfaces are disposed parallel to the horizontal plane XY. The piezoelectric charge Q20+, Q20− comprises a first piezoelectric charge Q20+ and a second piezoelectric charge Q20−. In the cross-section shown in FIG. 2, first piezoelectric charge Q20+ is generated on a surface of the sensor material 20 facing away from the base body diaphragm 11, and second piezoelectric charge Q20− is generated on a surface of the sensor material 20 that faces the base body diaphragm 11. In the following description, the first piezoelectric charge Q20+ is preferably converted into a pressure signal PS, while the second piezoelectric charge Q20− is preferably used as a ground potential signal MS.

The sensitivity σ of the sensor device 1 is of great importance. The sensitivity σ is the ratio of the measured value to the input value of the pressure P to be measured. The sensitivity σ decreases cubically with the increase in thickness T11 of the base body diaphragm 11. Moreover, it decreases quadratically with the decrease in diameter D11 of the base body diaphragm 11. Thus, the sensitivity σ of the sensor device 1 decreases with increase in the ratio of the thickness T11 to the diameter D11 of the base body diaphragm 11.
For a thickness T11 of the base body diaphragm 11 equal to 5 μm and a diameter D11 of the base body diaphragm 11 equal to 300 μm and a resulting ratio of thickness T11 to diameter D11 of the base body diaphragm 11 equal to 1.7 10⁻², the resulting sensitivity σ of the sensor device 1 for AlN as the sensor material is about 5 pC/bar.
For a thickness T11 of the base body diaphragm 11 equal to 5 μm and a diameter D11 of the base body diaphragm 11 equal to 200 μm and a resulting ratio of thickness T11 to diameter D11 of the base body diaphragm 11 equal to 2.5 10⁻², the resulting sensitivity σ of the sensor device 1 for AlN as the sensor material is about 0.5 pC/bar.
For a thickness T11 of the base body diaphragm 11 equal to 5 μm and a diameter D11 of the base body diaphragm 11 equal to 100 μm and a resulting ratio of thickness T11 to diameter D11 of the base body diaphragm 11 equal to 5.0 10⁻², the resulting sensitivity σ of the sensor device 1 for AlN as the sensor material is about 0.05 pC/bar.

### The Pressure Sensor 1P

The sensor device 1 comprises a plurality of sensor electrodes 21, 23. The sensor electrodes 21, 23 are configured to perform the function of tapping the piezoelectric charge Q20+, Q20− from the surfaces of the sensor material 20.

Said sensor electrodes 21, 23 are disposed in the region of the surfaces of the sensor material 20 where piezoelectric charge Q20+, Q20− is generated. The sensor electrodes 21, 23 comprise a first sensor electrode 21 and a second sensor electrode 23. The sensor electrodes 21, 23 are made of electrically conductive material such as silver (Ag), gold (Au), platinum (Pt) and the like and desirably can be created and put in place by any standard process such as chemical vapor deposition, physical vapor deposition or lithography.

In the cross-section shown in FIG. 2, the first sensor electrode 21 is disposed on the surface of the sensor material 20 facing away from the base body diaphragm 11 and taps the first piezoelectric charge Q20+. The second sensor electrode 23 is arranged on the surface of the sensor material 20 that faces the base body diaphragm 11 and taps the second piezoelectric charge Q20−. Each of the two sensor electrodes 21, 23 forms a layer extending parallel to the horizontal plane XY. Parallel to the horizontal plane XY, the first sensor electrode 21 comprises a first sensor base area D21 and the second sensor electrode 23 comprises a second sensor base area D23. Along the vertical axis Z, each of the two sensor electrodes 21, 23 has a constant thickness of less than or equal to 200 nm.

Compared to the piezoelectric sensor device of type 603C having a diaphragm that is 5.5 mm in diameter, the base body diaphragm 11 according to the invention is about one order of magnitude smaller. The base body diaphragm 11 is miniaturized. The surface of the diaphragm of type 603C has space for more than one hundred base body diaphragms 11 according to the invention. The base body diaphragm 11, the sensor material 20 arranged on it and the sensor electrodes 21, 23 arranged on the surfaces of the sensor material 20 form a miniaturized pressure sensor 1P which not only generates piezoelectric charge Q20+, Q20− for the pressure P to be measured, but which also comprises sensor electrodes 21, 23 for tapping this piezoelectric charge Q20+, Q20− from the surfaces of the sensor material 20.

The profile rigidity of the base body diaphragm 11 is not constant across its diameter D11. The profile rigidity is constant in a central region of the base body diaphragm 11 along the vertical direction Z, but in a peripheral region in the transition to the stop layer 15 and to the support layer 13, the profile rigidity increases. However, with increasing profile rigidity in the peripheral region of the base body diaphragm 11, the sensitivity σ of the sensor device 1 and, thus, also the generation of piezoelectric charge Q20+, Q20−, are decreased there. This decrease in sensitivity σ of the sensor device 1 in the peripheral region of the base body diaphragm 11 distorts the measurement of the pressure P. Preferably, no first piezoelectric charge Q20+ is tapped at all in the peripheral region, which first piezoelectric charge Q20+ is preferentially used as the pressure signal PS, so that the decrease in sensitivity σ of the sensor device 1 in the peripheral region of the base body diaphragm 11 is avoided. For this reason, the diameter of the first sensor base region D21, from which the first piezoelectric charge Q20+ is tapped, is smaller than the diameter D11 of the base body diaphragm 11. Preferably, the first sensor base region D21 is less than or equal to 80%, preferably less than or equal to 60% of the diameter D11 of the base body diaphragm 11.

The second sensor base region D23, on the other hand, from which the second piezoelectric charge Q20− is tapped, which second piezoelectric charge Q20− is preferably used as the ground potential signal MS, is preferably larger than or equal to the diameter D11 of the base body diaphragm 11.

The sensor device 1 comprises a plurality of sensor contact points 22, 24 schematically depicted in FIGS. 1 and 2 for example. Said sensor contact points 22, 24 have the function of providing an electrical contact between the sensor electrodes 21, 23 and the transmission device 5 schematically shown in FIGS. 4 and 5.

The sensor contact points 22, 24 are made of electrically conductive material such as Ag, Au, Pt and the like and desirably can be created and put in place by any standard process such as chemical vapor deposition, physical vapor deposition or lithography.

The sensor contact points 22, 24 comprise a first sensor contact point 22 and a second sensor contact point 24. The first sensor contact point 22 is arranged on the first sensor electrode 21 and configured so as to provide an electrical contact with the first sensor electrode 21. The second sensor contact point 24 is arranged on the second sensor electrode 23 and configured so as to provide an electrical contact with the second sensor electrode 23. Each of the two sensor contact points 22, 24 has a planar extension parallel to the horizontal plane XY, and such planar extension is configured to be large enough to achieve the electrical contact such as by thermosonic ball-wedge bonding, ultrasonic wedge-wedge bonding and the like.

The base body diaphragm 11, the sensor material 20 disposed on the front surface F11 of the base body diaphragm 11 and the sensor electrodes 21, 23 disposed on the surfaces of the sensor material 20 form the pressure sensor 1P of the embodiments of the sensor device 1 shown in FIGS. 1 to 3. The piezoelectric charge Q20+, Q20− is the measured value of the pressure sensor 1P. The permanent operating temperature of the pressure sensor 1P is in the range from −40° C. to +500° C.

### The Group of Pressure Sensors 1P

According to the second embodiment of the sensor device 1, the base body 10 comprises a plurality of base body diaphragms 11.

The plurality of base body diaphragms 11 are preferably arranged on the front face of the base body 10 lying in the horizontal plane XY. As schematically shown in FIG. 3, the pressure P to be measured acts onto the front surfaces F11 of the plurality of base body diaphragms 11 along the vertical direction Z and deflects the plurality of base body diaphragms 11. Sensor material 20 is disposed on at least one region of the front surface F11 of each of the plurality of base body diaphragms 11. The sensor material 20 is configured to generate piezoelectric charge Q20+, Q20− due to the deflection of the base body diaphragm 11. On each of the plurality of base body diaphragms 11, the first sensor electrode 21 is arranged on the surface of the sensor material 20 that faces away from the base body diaphragm 11 and taps first piezoelectric charge Q20+. The second sensor electrode 23 is arranged on the surface of the sensor material 20 that faces the base body diaphragm 11 and taps second piezoelectric charge Q20−.

According to the second embodiment, the sensor device 1 comprises a plurality of sensor group conductors 25, 27. The sensor group conductors 25, 27 are configured to function to collect the piezoelectric charge Q20+, Q20−.

The sensor group conductors 25, 27 are made of electrically conductive material such as Ag, Au, Pt and the like and desirably can be created and put in place by any standard process such as chemical vapor deposition, physical vapor deposition or lithography.

The sensor group conductors 25, 27 are in the region of the two surfaces of the sensor material 20. The sensor group conductors 25, 27 comprise a first sensor group conductor 25 and a second sensor group conductor 27. The first sensor group conductor 25 is configured to make an electrical contact to the first sensor electrodes 21 in a manner that electrically connects the first sensor electrodes 21 in series. The second sensor group conductor 27 is configured to make an electrical contact to the second sensor electrodes 23 in a manner that electrically connects the second sensor electrodes 23 in series.

The plurality of base body diaphragms 11 on which sensor material 20 is disposed on front surfaces F11, the sensor material 20 that is disposed on the plurality of base body diaphragms 11 and the sensor electrodes 21, 23 and sensor group conductors 25, 27 disposed on the surfaces of this sensor material 20 are thus connected to form a group of pressure sensors 1P.

Advantageously, a plurality of more than or equal to two base body diaphragms 11, preferably a plurality of more than or equal to sixteen base body diaphragms 11, preferably a plurality of more than or equal to 128 base body diaphragms 11 are formed in the base body 10.

The increase in the natural frequency f1 of the sensor device 1 according to the invention is achieved by decreasing the ratio of the thickness T11 to the diameter D11 of the base body diaphragm 11. However, this decreased ratio also reduces the sensitivity σ of the sensor device 1 according to the invention. The sensitivity σ changes quadratically with the diameter D11 of the base body diaphragm 11. When the thickness T11 is kept constant, dividing the diameter D11 of the base body diaphragm 11 in half will reduce the amount of generated piezoelectric charge Q20+, Q20− by a factor of four. By providing a plurality of base body diaphragms 11 in the base body 10, with sensor material 20 being disposed on each front surface F11 of the plurality of base body diaphragms 11, and by connecting the sensor electrodes 21, 23 that tap the piezoelectric charge Q20+, Q20− of the sensor material 20 in series, the reduction in sensitivity σ of the sensor device 1 according to the invention can be counterbalanced and even increased.

According to the second embodiment, the sensor device 1 comprises a plurality of sensor group contact points 26, 28. The sensor group contact points 26, 28 are configured to function to provide an electrical contact to the transmission device 5.

The sensor group contact points 26, 28 are made of electrically conductive material such as Ag, Au, Pt and the like and desirably can be created and put in place by any standard process such as chemical vapor deposition, physical vapor deposition or lithography.

The sensor group contact points 26, 28 comprise a first sensor group contact point 26 and a second sensor group contact point 28. The first sensor group contact point 26 is disposed on the first sensor group conductor 25 and makes electrical contact with the first sensor group conductor 25. The second sensor group contact point 28 is disposed on the second sensor group conductor 27 and makes electrical contact with the second sensor group conductor 27. Each of the two sensor group contact points 26, 28 desirably is configured to form a planar extension parallel to the horizontal plane XY having a size designed to be large enough for achieving an electrical contact by bonding such as thermosonic ball wedge bonding, ultrasonic wedge-wedge bonding and the like.

### The Transmission Device 5

The transmission device 5 is configured to perform the function of transmitting the piezoelectric charge Q20+, Q20−.

The transmission device 5 comprises a plurality of charge transmitters 51, 52 made of electrically conductive material such as copper (Cu), Ag, Au and the like. The charge transmitters 51, 52 desirably are wires, typically 15 to 200 μm in diameter.

The charge transmitters 51, 52 comprise a first charge transmitter 51 and a second charge transmitter 52.

As shown in the schematic circuit diagram of FIG. 4, an electrical contact is established on the first sensor contact point 22 with the first charge transmitter 51, and an electrical contact is established on the second sensor contact point 24 with the second charge transmitter 52. These charge transmitters 51, 52 are configured to transmit piezoelectric charge Q20+, Q20− away from the sensor contact points 22, 24.

As shown in the schematic circuit diagram of FIG. 5, an electrical contact is established on the first sensor group contact point 26 with the first charge transmitter 51, and an electrical contact is established on the second sensor group contact point 28 with the second charge transmitter 52. These charge transmitters 51, 52 are configured to transmit piezoelectric charge Q20+, Q20− away from the two sensor group contact points 26, 28.

When the measuring frequency f* significantly exceeds 100 kHz, a wave impedance Z5 of the transmission device 5 must be taken into consideration. This is because the piezoelectric charge Q20+, Q20− of the charge transmitters 51, 52 generates a magnetic field and thus an inductance. Furthermore, the charge transmitters 51, 52 form a capacitance in relation to each other. The wave impedance Z5 is dependent on both the inductance and the capacitance of the transmission device 5. The wave impedance Z5 results in electromagnetic waves which are reflected at the ends of the transmission device 5. The reflections of the electromagnetic waves may distort the measurement of the pressure P. To avoid such reflections, at least one end of the transmission device 5 is electrically terminated by an electrical resistor. The electrical resistor absorbs incoming electromagnetic waves. Said electrical resistance is equal to the wave impedance Z5 of the transmission device 5. Depending on the industry standard, the wave impedance Z5 is 50Ω or 75Ω for a transmission device 5 in the form of a coaxial line. Similarly, the wave impedance Z5 is in the range from 100Ω to 300Ω for a transmission device 5 in the form of a two-wire line.

### The Transducer Unit 6

The transducer unit 6 is configured to function to electrically convert transmitted piezoelectric charge Q20+, Q20− into at least one measurement signal PS, MS.

The measurement signal PS, MS comprises a pressure signal PS and a ground potential signal MS. The pressure signal PS corresponds to the first piezoelectric charge Q20+. The ground potential signal MS corresponds to the second piezoelectric charge Q20−.

As shown in the schematic circuit diagrams of FIGS. 4 and 5, the transducer unit 6 comprises at least one operational amplifier 61, at least one feedback capacitance 62, at least one first charge input contact 63, at least one second charge input contact 65, at least one signal output contact 66, and at least one ground potential output contact 67.

The operational amplifier 61 includes an inverting input i−, a non-inverting input i+ and a signal output o. The inverting input i− is provided with high electrical insulation with a small leakage current of less than or equal to 10⁻¹⁴ A (amperes). The inverting input i− of the transducer unit 6 has an input impedance Z61 which is close to 0Ω. The non-inverting input i+ is connected to a ground potential 64 of the sensor device 1. The ground potential 64 is an electrical reference potential such as zero volts (0 V). The ground potential 64 may be the electrical potential of the electrically conductive ground at the site of the sensor device 1.

The charge input contacts 63, 65 are configured to perform the function of providing an electrical contact between the transducer unit 6 and the transmission device 5. The charge input contacts 63, 65 are made of electrically conductive material such as Cu, Ag, Au and the like and desirably can be created and put in place by any standard process such as chemical vapor deposition, physical vapor deposition or lithography.

The first charge transmitter 51 is depicted in FIG. 4 at one end of the transmission device 5 that is connected to the inverting input i− of the operational amplifier 61. By the first charge input contact 63, the first charge transmitter 51 is in electrical contact with the inverting input i− of the operational amplifier 61. Thus, the second piezoelectric charge Q20+ of the pressure sensor 1P and of the group of pressure sensors 1P are applied to the inverting input i− of the operational amplifier 61. The second piezoelectric charge Q20+ forms an electric current supplied to the inverting input i−.

The second charge transmitter 52 is in electrical contact with the ground potential 64 via the second charge input contact 65. Thus, the first piezoelectric charge Q20− of the pressure sensor 1P as well as the group of pressure sensors 1P are at ground potential 64.

The operational amplifier 61 is configured to function to amplify piezoelectric charge Q20+ at the inverting input i−.

The operational amplifier 61 is configured to operate to reduce the voltage difference between the inverting input i− and the non-inverting input i+ to zero. To this end, the piezoelectric charge Q20+ to be amplified flows from the inverting input i− as an electric current into the operational amplifier 61 and generates an electrical output voltage at the signal output o.

The operational amplifier 61 has an operating frequency f61. The operating frequency f61 is the highest frequency by which the operational amplifier 61 is able to amplify the piezoelectric charge Q20+. Preferably, the operating frequency f61 is greater than or equal to 50 MHz, preferably greater than or equal to 500 MHz.

The feedback capacitance 62 is connected in parallel to the inverting input i− and to the signal output o of the operational amplifier 61.

The feedback capacitance 62 is configured to function to adjust an amplification factor of the transducer unit 6. The feedback capacitance 62 is connected between the inverting input i− and the signal output o of the operational amplifier 61. Through the feedback capacitance, the electrical output voltage applied to the signal output o flows back to the inverting input i− as an electrical current 62. The amount of electrical current flowing back depends on the magnitude C62 of the feedback capacitance 62. The larger the feedback capacitance 62 is, then the more electrical current flows back to the inverting input i−, where the electrical current then flows into the operational amplifier 61 in addition to the piezoelectric charge Q20+ to be amplified. Preferably, the magnitude C62 of the feedback capacitance 62 is in the range of 10 pF to 1000 pF.

The input impedance Z61 at the inverting input i− is inversely proportional to the product of the operating frequency f61 of the operational amplifier 61 and the magnitude C62 of the feedback capacitance 62, and this mathematical relationship can be represented symbolically as follows:

$$Z 61 ∝ \frac{1}{f 61 * C 62}$$

To avoid reflections of the electromagnetic waves in the transmission device 5 and at the inverting input i−, the wave impedance Z5 of the transmission device 5 is matched with the input impedance Z61 at the inverting input i−. For this purpose, a balancing impedance Z6 is electrically connected between one end of the transmission device 5 towards the inverting input i− and the inverting input i− as schematically shown in FIGS. 4 and 5. The following mathematical relationship describes the magnitude of the adjustment of the wave impedance Z5 of the transmission device 5 in terms of the input impedance Z61 and the balancing impedance Z6:

$$Z 5 = Z 61 + Z 6$$

The balancing impedance Z6 is in the same order of magnitude of the wave impedance Z5 of the transmission device 5. Preferably however, the balancing impedance Z6 is less than or equal to the wave impedance Z5 of the transmission device 5. For the wave impedance Z5 of a transmission device 5 designed as a coaxial line of 50Ω or 75Ω, the balancing impedance Z6 is less than or equal to this wave impedance Z5 of a coaxial line of 50Ω or 75Ω. For the wave impedance Z5 of a transmission device 5 designed as a two-wire line in the range of 100Ω to 300Ω, the balancing impedance Z6 is less than or equal to this wave impedance Z5 of this two-wire line in the range of 100Ω to 300Ω. Preferably, the balancing impedance Z6 is less than or equal to 300Ω, preferably less than or equal to 75Ω, preferably less than or equal to 50Ω.

The following is a numerical example. For a proportionality factor between the input impedance Z61 at the inverting input i− and the product of the operating frequency f61 of the operational amplifier 61 and the magnitude C62 of the feedback capacitance 62 of 2π as well as an operating frequency f61 of the operational amplifier 61 of 500 MHz and a magnitude C62 of the feedback capacitance 62 of 100 pF, an input impedance Z61 at the inverting input i− equals 3.2Ω. For matching this with a wave impedance Z5 of the transmission device 5 designed as a coaxial line of 50Ω, the balancing impedance Z6 is then 46.8Ω.

The pressure signal PS is the electrical output voltage applied to the signal output o of the operational amplifier 61. The pressure signal PS corresponds to the quantity of the first piezoelectric charge Q20+. The transducer unit 6 is configured to amplify each first piezoelectric charge Q20+ to yield a pressure signal PS.

The signal output contact 66 and the ground potential output contact 67 are configured to function to provide an electrical contact between the transducer unit 6 and the evaluation unit 7. The signal output contact 66 and the ground potential output contact 67 are made of electrically conductive material such as Cu, Ag, Au and the like and desirably can be created and put in place by any standard process such as chemical vapor deposition, physical vapor deposition or lithography.

The signal output o of the operational amplifier 61 is electrically connected with the signal output contact 66. The pressure signal PS is applied to the signal output contact 66. The ground potential output contact 67 is electrically connected with the ground potential 64. The ground potential signal MS is applied to the ground potential output contact 67.

### The Evaluation Unit 7

The evaluation unit 7 is configured to perform the function of evaluating the sensor signals PS, MS.

For this purpose, the evaluation unit 7 comprises at least one signal conductor 71, at least one ground potential conductor 72, at least one interface 73, at least one computing unit 74, at least one input unit 75, and at least one output unit 76.

The signal conductor 71 and the ground potential conductor 72 are made of electrically conductive material such as Cu, Ag, Au and the like and desirably can be created and put in place by any standard process such as chemical vapor deposition, physical vapor deposition or lithography.

An electrical contact with the signal conductor 71 is established at the first signal output contact 66, and an electrical contact with the ground potential conductor 72 is established at the first ground potential output contact 72. The signal conductor 71 is configured and disposed to transmit the pressure signal PS electrically to the interface 73. The ground potential conductor 72 is configured and disposed to transmit the ground signal MS electrically to the interface 73.

The interface 73 is configured to perform the function of digitizing the measurement signals PS, MS to yield digital measurement data elements PD, MD.

For this purpose, said interface 73 comprises at least one transducer element such as an analog-to-digital transducer and the like. The transducer element is configured for digitizing the measurement signals PS, MS to yield digital measurement data elements PD, MD. Each measurement data element PD, MD specifies a measurement data amount pv, my for a measured value of the pressure. Each measurement data element PD, MD is a binary number sequence with a resolution of 12 bits, 16 bits and so on.

The interface 73 also comprises at least one timer such as a clock and the like. Said timer is configured to assign a respective time point pt, mt to each measurement data element PD, MD. Each respective time point pt, mt is a binary number sequence with a resolution of 12 bits, 16 bits and the like. The respective time point pt, mt assigned to a measurement data element PD, MD is hereinafter also referred to as the time point pt, mt associated with the measurement data element PD, MD. At the time point pt, mt, the interface 73 has digitized a sensor signal PS, MS into the measurement data element PD, MD. The time point pt, mt has a temporal resolution which, according to the Nyquist-Shannon sampling theorem, is equal to the reciprocal value of twice the measurement frequency f*. For a measurement frequency f* that is at most ⅓ of the natural frequency f1 of greater than or equal to 1 MHz, the time point pt, mt has a temporal resolution of greater than or equal to 3/2 10⁻⁶ sec.

The measurement data elements PD, MD comprise at least one pressure data element PD with a pressure amount pv, and the time points pt, mt comprise at least one pressure time point pt associated with the pressure data element PD. The interface 73 is configured to digitize each pressure signal PS to yield a pressure data element PD with a pressure amount pv and provides the pressure data element PD with an associated pressure time point pt.

The measurement data elements PD, MD as shown in the schematic diagrams of FIGS. 4 and 5 also comprise at least one ground potential data element MD with a ground potential amount mv, and the time points pt, mt comprise at least one ground potential time point mt associated with the ground potential data element MD.

The computing unit 74 comprises at least one data memory and at least one data processor electrically connected to the data memory.

The computing unit 74 includes at least one evaluation program AP which is stored in the data memory and which the data processor is configured to extract from the data memory and process in the data processor. The evaluation program AP loaded into the data processor is configured to be operated by the data processor to evaluate the measurement data elements PD, MD with the measurement data amounts pv, my and the time points pt, mt.

The computing unit 74 can be operated by means of the input unit 75. The verb “operate” has the meaning that a human subject can enter commands by means of the input unit 75, which commands are then executed by the computing unit 74. The input unit 75 may be a keyboard or a touch-sensitive screen for entering commands. Commands can be entered by the input unit 75 as a string of characters, and the evaluation program AP loaded into the data processor is configured to generate control data for entered commands. Thus, the command entered may be to switch on or to switch off the sensor device 1, and the evaluation program AP loaded into the data processor is configured to generate control data for the command, which control data switch on or switch off the sensor device 1.

Moreover, the evaluation program AP loaded into the data processor is also configured to graphically display the measurement data elements PD, MD and the date elements t via the output unit 76 for evaluation. The output unit 76 may be a screen on which the measurement data elements PD, MD are graphically displayed to the human subject.

Those skilled in the art knowing the present invention may implement a wide variety of variations of the embodiments presented. For example, the pressure sensor 1P, the transmission device 5 and the transducer unit 6 may be implemented within a housing at the site where the pressure P is measured.

List of reference symbols

| | |
|---|---|
| 1 | Sensor device |
| 1P | Pressure sensor |
| 5 | Transmission device |
| 6 | Transducer unit |
| 7 | Evaluation unit |
| 10 | Base body |
| 11 | Base body diaphragm |
| D11 | Diameter of base body diaphragm |
| F11 | Front surface of the base body diaphragm |
| F12 | Rear surface of the base body diaphragm |
| T11 | Thickness of the base body diaphragm |
| 12 | Base body opening |
| 13 | Supporting layer |
| 14 | Boundary layer |
| 15 | Stop layer |
| 20 | Sensor material |
| D20 | Base region of the sensor material |
| T20 | Thickness of the sensor material |
| 21 | First sensor electrode |
| D21 | Base region of the first sensor electrode |
| 22 | First sensor contact point |
| 23 | Second sensor electrode |
| D23 | Base region of the second sensor electrode |
| 24 | Second sensor contact point |
| 25 | First sensor group conductor |
| 26 | First sensor group contact point |
| 27 | Second sensor group conductor |
| 28 | Second sensor group contact point |
| 51 | First charge transmitter |
| 52 | Second charge transmitter |
| 61 | Operational amplifier |
| − | Inverting input |
| + | Non-inverting input |
| o | Signal output |
| 62 | Feedback capacitance |
| C62 | Magnitude of Feedback capacitance |
| 63 | First charge input contact |
| 64 | Ground potential |
| 65 | Second charge input contact |
| 66 | Signal output contact |
| 67 | Ground potential output contact |
| 71 | Signal conductor |
| 72 | Ground potential conductor |
| 73 | Interface |
| 74 | Computing unit |
| 75 | Input unit |
| 76 | Output unit |
| AP | Evaluation program |
| A - A | Section path |
| f1 | Natural frequency |
| f* | Measuring frequency |
| f61 | Operating frequency |
| MD | Ground potential data element |
| MS | Ground potential signal |
| mt | Ground potential time point |
| mv | Ground potential amount |
| P | Pressure |
| PD | Pressure data element |
| PS | Pressure signal |
| pt | Pressure time point |
| pv | Pressure amount |
| Q20+ | First piezoelectric charge |
| Q20− | Second piezoelectric charge |
| σ | Sensitivity |
| X | Horizontal axis |
| XY | Horizontal plane |
| Y | Transverse axis |
| Z | Vertical axis |
| Z5 | Wave impedance |
| Z6 | Balancing impedance |
| Z61 | Input impedance |

What is claimed is:

1. A piezoelectric high-pressure sensor for measuring a pressure of up to 10 kbar; the sensor comprising:
a housing, a diaphragm and a measuring unit;
wherein said housing is hollow-cylindrical in shape and comprises a shell that elongates along a longitudinal axis and a cavity, which shell is formed to include at least one mounting means, which is configured and disposed to permit the piezoelectric high-pressure sensor to be mounted at a measurement site;
which measuring unit is arranged in the cavity and comprises at least one measuring element made of piezoelectric material;
which diaphragm is disc-shaped and defines a central area and a peripheral area spaced radially from the central area, which diaphragm is configured to receive the pressure to be measured at the central area and to transmit the pressure along the longitudinal axis into the measuring unit, and which diaphragm is connected to the shell at the peripheral area by a bond between the shell and the peripheral area of the diaphragm;
wherein the measuring element is rod-shaped and functions according to a piezoelectric transverse effect;
wherein the measuring element has a length along the longitudinal axis and a cross-sectional area normal to the longitudinal axis;
wherein a ratio of the length to the cross-sectional area is in a range from greater than or equal to 1.0 mm⁻¹ to less than or equal to 1.5 mm⁻¹; and
wherein the shell has a diameter of less than or equal to 10 mm.

2. The piezoelectric high-pressure sensor according to claim 1, wherein the length of the measuring element is less than or equal to 3.0 mm.

3. The piezoelectric high-pressure sensor according to claim 1, wherein the length of the measuring element is less than or equal to 2.4 mm.

4. The piezoelectric high-pressure sensor according to claim 1, wherein the measuring unit comprises exactly three measuring elements.

5. The piezoelectric high-pressure sensor according to claim 4, wherein each of the three measuring elements has a cross-sectional area in the range of greater than or equal to 1.5 mm² and smaller than or equal to 2.5 mm²; and
wherein the total cross-sectional area of the three measuring elements is in the range of greater than or equal to 4.5 mm² and smaller than or equal to 7.5 mm².

6. The piezoelectric high-pressure sensor according to claim 1, wherein the piezoelectric material of the measuring element is a single crystal of SiO₂; and
wherein the piezoelectric material of SiO₂ has a coefficient of elasticity of 87 kN/mm² along the longitudinal axis.

7. The piezoelectric high-pressure sensor according to claim 6, wherein the shell is made of mechanically resistant material having a modulus of elasticity of greater than 200 kN/mm²; and
wherein the coefficient of elasticity of the piezoelectric material of SiO₂ is smaller by more than a factor of two than that of the material of the shell such that under the effect of the pressure the piezoelectric material of the measuring element is compressed more strongly along the longitudinal axis than the material of the shell is compressed along the longitudinal axis.

8. The piezoelectric high-pressure sensor according to claim 1, wherein the piezoelectric material of the measuring element is a single crystal of GaPO₄; and
wherein the piezoelectric material of GaPO₄ has a coefficient of elasticity of 67 kN/mm² along the longitudinal axis.

9. The piezoelectric high-pressure sensor according to claim 8, wherein the shell is made of mechanically resistant material having a modulus of elasticity of greater than 200 kN/mm²; and
wherein the coefficient of elasticity of the piezoelectric material of GaPO₄ is smaller by a factor of three than that of the material of the shell such that under the effect of the pressure the piezoelectric material of the measuring element is compressed more strongly along the longitudinal axis than the material of the shell is compressed along the longitudinal axis.

10. The piezoelectric high-pressure sensor according to claim 1, wherein the central area of the diaphragm is in an indirect planar contact with the measuring element such that compression of the piezoelectric material of the measuring element causes tensile and compressive stresses in the central area of the diaphragm;
wherein the central area of the diaphragm has a thickness of less than or equal to 0.5 mm measured along a direction that is normal to the longitudinal axis; and
wherein for a length of the measuring element of less than or equal to 2.4 mm measured along the longitudinal axis, the tensile and compressive stresses at a pressure of up to 10 kbar are at a level that is harmless for the mechanical stability of the central area of the diaphragm.

11. The piezoelectric high-pressure sensor according to claim 1, wherein the central area of the diaphragm is in an indirect planar contact with the measuring element such that compression of the piezoelectric material of the measuring element causes tensile and compressive stresses in the central area of the diaphragm; and
wherein the central area of the diaphragm has a thickness of less than or equal to 0.5 mm measured along a direction that is normal to the longitudinal axis; and wherein for a length of the measuring element of less than or equal to 3.0 mm measured along the longitudinal axis, the tensile and compressive stresses at a pressure of up to 10 kbar are at a level that is harmless for the mechanical stability of the central area of the diaphragm.

12. The piezoelectric high-pressure sensor according to claim 1, wherein the mounting means is configured to a mounting bore forming an M10 screw connection having a tightening torque of no more than 20 Nm in a mounted state and wherein the piezoelectric high-pressure sensor is held in the mounting bore with a hold-down force of less than or equal to 20 kN.

13. The piezoelectric high-pressure sensor according to claim 12, wherein the diaphragm defines an impact surface that extends perpendicularly to the longitudinal axis and is disposed on a face of the diaphragm that faces away from the cavity such that the pressure to be measured acts directly onto the impact surface by an impact force; and
wherein the dimension of the impact surface is such that a combination of the hold-down force and the impact force does not lead to harmful stress peaks with plastic deformation or breakage in the materials of the piezoelectric high-pressure sensor.

14. The piezoelectric high-pressure sensor according to claim 13, wherein for a pressure of 10 kbar the size of the impact surface is smaller than or equal to 20 mm².

15. The piezoelectric high-pressure sensor according to claim 1, wherein the piezoelectric material of the measuring element is a single crystal that has a piezoelectric coefficient for the piezoelectric transverse effect that renders the sensitivity of the piezoelectric high-pressure sensor to be proportional to the product of the piezoelectric coefficient of the piezoelectric material of the measuring element and the ratio of the length to the cross-sectional area of the measuring element.

16. The piezoelectric high-pressure sensor according to claim 15, wherein for SiO₂ as the piezoelectric material of the measuring element, the piezoelectric coefficient equals 2.3 pC/N; and
wherein for the ratio of length to cross-sectional area of the measuring element in the range of greater than or equal to 1.0 mm⁻¹ and less than or equal to 1.5 mm⁻¹, the sensitivity of the piezoelectric high-pressure sensor is greater than or equal to 1.0 pC/bar.

17. The piezoelectric high-pressure sensor according to claim 15, wherein for GaPO₄ as the piezoelectric material of the measuring element the piezoelectric coefficient is 4.5 pC/N; and
wherein for the ratio of length to cross-sectional area of the measuring element in the range of greater than or equal to 1.0 mm⁻¹ and less than or equal to 1.5 mm⁻¹, the sensitivity of the piezoelectric high-pressure sensor is greater than or equal to 1.0 pC/bar.
